(19) United States
(12) Patent Application Publication
(10) Pub. No.: US 2009/0168918 A1
(43) Pub. Date: Jul. 2, 2009

(54) Differential signal modulating apparatus and method thereof

(76) Inventors: Shuei-Lin Chen, Kaohsiung City (TW); Wen-Bin Wang, Shengang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,347

(22) Filed: Sep. 16, 2008

(30) Foreign Application Priority Data
Dec. 26, 2007 (TW) 96150274

(51) Int. Cl. H04L 27/00

(52) U.S. Cl. 375/295; 375/316

(57) ABSTRACT

A differential signal modulating apparatus and method thereof is provided. The differential signal modulating apparatus receives differential signal pairs from a transmitter, and generates multimedia streams. It is controlled by modulating the reception sequence of differential pairs to match with the transmitted sequence of differential pairs sent from the transmitter. In addition, the present invention method can be extensively applied to various interfaces.

### BACKGROUND OF THE INVENTION

1. Field of the Invention

The present invention relates to a differential signal modulating apparatus and method thereof, and more particularly, to a differential signal modulating apparatus which may alter the transmission sequence of differential signals, and method thereof.

2. Description of Related Art

As wireless communication becomes more and more popular in recent years, digital audio/video streams can now be conveniently transferred between hand-held devices. Operational speeds of processors in hand-held devices get faster than before, whereas the amount of data required to be processed within a unit of time is also rapidly booming, hence it is necessary to look for a type of interface circuit which is capable of transferring and receiving in high volume of data for data transmission. In addition to using optic fiber as a tool for data transmission, conventional parallel interfaces attempt to achieve the objective of increasing bandwidth and transmission rate by means of augmenting number of transmission lines, but due to the restrictions of area or size of printed circuit board (PCB) in hand-held devices, thus the industry gradually develops new serial interfaces for data transmission.

New serial interfaces, e.g. SMIA, MPL, MVI etc., are all generally developed based on the architecture of Low Voltage Differential Signal (LVDS) technology. Taking SMIA for example, which referring to the “Standard Mobile Imaging Architecture”, it is specifically directed to the interfaces between camera module and mobile phone core system and creates a set of standard specifications. Compared with traditional parallel interfaces, SMIA employs differential serial port for differential signal output, hence it can still provide the advantage of high speed data transmission even in the environment of low voltage power supply.

Referring to FIG. 1, therein a diagram of differential signal transmission over the prior art new serial interface is shown. As illustrated in FIG. 1, a data flow D and a clock signal S are transferred from a transmitter 11 to a receiver 13, and the data flow D is converted into a differential pair through a differential amplifier 111, in which the said pair consists of a data positive signal D+ and a data complementary negative signal D−; besides, the clock signal S is also converted into a differential pair through a differential amplifier 113, in which the said pair consists of a clock positive signal S+ and a clock complementary negative signal S−. By using differential amplifiers 131, 133 to respectively perform operations on the data positive signal D+, data complementary negative signal D− as well as the clock positive signal S+ and clock complementary negative signal S−, the receiver 13 can restore the data flow D and the clock signal S.

Although the data transmission by using differential signal indeed provides the aforementioned advantages, during the data transmission from the transmitter to the receiver, however, the order of differential signal must avoid being crossed and twisted, so as to reduce the phenomena of electro-magnetic interference (EMI) and coupled interference between differential signals. Therefore, the sequence that the transmitter 11 transfers the differential signals is {D+, D−, S+, S−}, the receiver 13 also needs to define the sequence of {D+, D−, S+, S−} to receive differential signals in order to receive the data correctly. Compared with the conventional parallel interfaces, the new serial interfaces provide the advantages of less transmission lines and increased bandwidth, but the order of differential signals transferred by interface pins is not yet defined, and, accordingly, the interface for the development among various types of chips and hand-held designers still needs a unified standard.

### SUMMARY OF THE INVENTION

With regard to digital imaging data transmission with differential signal, in view of the problem that, in prior art, the transmission sequence of differential signal of the interface pins at the transmitter needs to be consistent with the transmission sequence of differential signal of the interface pins at the receiver; and, meanwhile, in view that after the reception of digital imaging data, it is desirable that, through modulating the transmission sequence of differential signal to the reception sequence inside the receiver, the transmission sequence of differential signal of the interface pin at the transmitter can be coordinated for receiving the digital imaging data, so as to be flexibly applied to various interface development.

Hence, the objective of the present invention is to provide a differential signal modulating apparatus and method thereof, which is able to modulate the transmission sequence of differential signal, so as to be flexibly applied to various interface development.

The present invention discloses a differential signal modulating apparatus, which is used for receiving a differential data pair and a differential clock pair from a transmitter, and further restoring the differential data pair and the differential clock pair into a multimedia stream. The transmitter defines a reception sequence of differential signal for transferring the differential data pair and the differential clock pair. The described differential signal modulating apparatus includes a transmitting unit, a modulating module and an operational module. The transmitting unit includes a plurality of differential amplifiers, used for receiving the differential data pair and the differential clock pair. The modulating module is coupled with the transmitting unit, used for adjusting the reception sequence of the differential data pair and the differential clock pair according to the reception sequence of differential signal, so as to further output a data flow and a clock signal. The operational module is coupled with the modulating module, used for receiving the data flow according to the status of the clock signal, and performing operational processes on the data flow, so as to generate the multimedia stream.

In an embodiment of the present invention, the modulating module includes a plurality of multiplexers, in which the output of each multiplexer is controlled by a selection signal, and the selection signal may be a user's input value or a system's setup value.

The present invention also discloses a differential signal modulating apparatus, which is used for receiving a differential data pair and a differential clock pair from a transmitter, and further restoring the differential data pair and the differential clock pair into a multimedia stream. The transmitter defines a reception sequence of differential signal for transferring the differential data pair and the differential clock pair. The described differential signal modulating apparatus includes a modulating module and a multiplexer. The described modulating module includes a plurality of transmitting units and a plurality of operational modules. The transmitting units include all combinations of reception sequences of the differential data pair and the differential clock pair. Each transmitting unit receives the differential data pair and the differential clock pair, and generates a data flow and a clock signal through a differential amplifier. The operational modules are coupled with the transmitting units in a one-by-one fashion, and each operational module is used for receiving the data flow according to the status of the clock signal, and further performing operational processes on the data flow, so as to generate an intermediate multimedia stream. The multiplexers are coupled with all of the operational modules, and outputs one of the intermediate multimedia stream by a selection signal as the multimedia stream.

In an embodiment of the present invention, the transmitting unit is a Low Voltage Differential Signaling (LVDS) transmitter.

In an embodiment of the present invention, the operations performed on the data flow include compression, decompression, combination, collection etc.

The present invention further discloses a method of differential signal modulation, which is used for receiving at least a differential pair, and the transmitter defines a reception sequence of differential signal for transferring the differential pair. The described method of differential signal modulation includes the following steps; that is, initially, receiving the differential pair according to the reception sequence of differential signal, performing operations on the differential pair by the differential amplifier then outputting an intermediate data flow; thereafter, adjusting the intermediate data flow according to the order of the differential signal; finally, performing process on the operationally-adjusted intermediate data flow for further outputting a multimedia stream.

The present invention yet alternatively discloses a method of differential signal modulation, which is used at a receiver for receiving from a transmitter at least a differential pair, in which the transmitter defines a reception sequence of differential signal for transferring the differential pair, and the receiver defines all combinations of transmission sequence of differential pair. The described method of differential signal modulation includes the following steps; that is, initially, receiving the differential pair according to the transmission sequence of all differential pairs, and outputting a plurality of intermediate data flows through the operation of the differential amplifier; next, performing operations on each of the intermediate data flow; finally, selecting one of the intermediate data flows as the output according to the reception sequence of differential pair.

The above-mentioned summary as well as subsequent descriptions and drawings are both for further illustrating the measures, means and effects taken by the present invention to achieve the prescribed objectives. Other goals and advantages of the present invention will be explained in details in the following descriptions and drawings.

### BRIEF DESCRIPTION OF THE DRAWINGS

FIG. 1 is a diagram of differential signal transmission over prior art new serial interface;

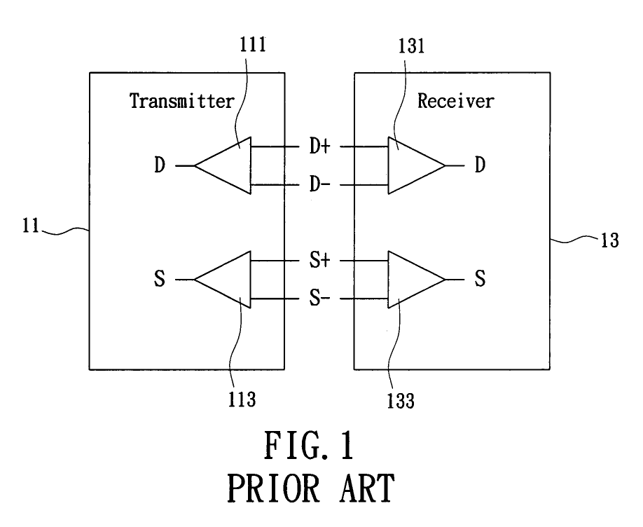

FIG. 2 is a system architecture diagram of a differential signal modulating apparatus according to an embodiment of the present invention;

FIG. 3 is a step-wise flowchart of the modulation method of the differential signal modulating apparatus according to an embodiment of the present invention;

FIG. 4 is a system architecture diagram of a differential signal modulating apparatus according to another embodiment of the present invention;

FIG. 5 is a step-wise flowchart of the modulation method of the differential signal modulating apparatus according to another embodiment of the present invention.

### DETAILED DESCRIPTION OF THE PREFERRED EMBODIMENTS

The present invention hereby provides a differential signal modulating apparatus and method thereof, wherein, after the reception of digital imaging data, through modulating the transmission sequence of differential signal, the transmission sequence of differential signal of the interface pin at the receiver can be coordinated for receiving the digital imaging data, offering hence the advantage of being able to be flexibly applied to various interface development.

If the transmitter transfers differential signals to the receiver, then the transmission sequence of the differential signal that the receiver receives must be consistent with the transmission sequence of the differential signal that the transmitter sends, so as to acquire correct data. However, since the interface specifications developed by each companies and manufacturer vary, if the receiver and the transmitter do not match, it is doomed to receive wrong information. Therefore, the present invention proposes that, after the reception of differential signal, the apparatus according to the present invention can be used to modulate the transmission sequence of differential signal, which coordinates the transmission sequence of differential signal at the receiver, so as to receive the correct information.

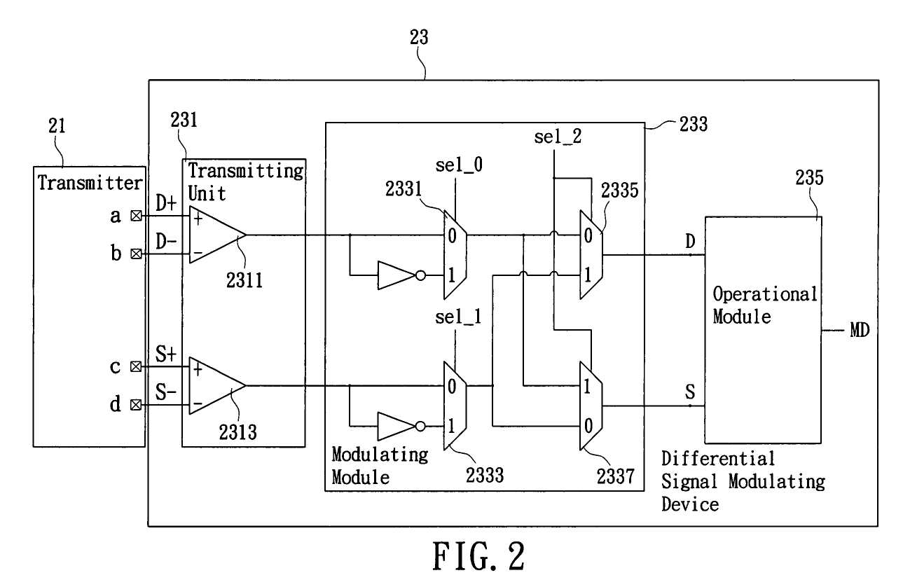

At the beginning, referring to FIG. 2, a system architecture diagram of a differential signal modulating apparatus according to an embodiment of the present invention is shown. As illustrated in FIG. 2, the transmitter 21 transmits a differential data pair and a differential clock pair, wherein the differential data pair includes data positive signal D+ and data complementary negative signal D−, the differential clock pair includes clock positive signal S+ and clock complementary negative clock signal S−. The differential signal can be sent respectively via interface pins a, b, c, d in 8 combination sequences, i.e. {D+, D−, S+, S−}, {D−, D+, S+, S−}, {D+, D−, S−, S+} {D−, D+, S−, S+}, {S+, S−, D+, D−}, {S−, S+, D+, D−}>{S+, S−, D−, D+}, {S−, S+, D−, D+}, and the receiver must use the same sequence to receive differential signal.

The receiver has a differential signal modulating apparatus 23, which is used for receiving the differential data pair and the differential clock pair, further generating multimedia stream MD. The described differential signal modulating apparatus 23 includes a transmitting unit 231, a modulating module 233 and an operational module 235.

The transmitting unit 231 includes two differential amplifiers 2311, 2313, which are used for receiving the differential data pair and the differential clock pair. The modulating module 233 is coupled with the transmitting unit 231, for adjusting the transmission sequences of the differential data pair and the differential clock pair, further outputting a data flow D and a clock signal S. The operational module 235 is coupled with the modulating module 233 for receiving the data flow D according to the status of the clock signal S, performing operations on the data flow D and further generating the multimedia stream MD.

The above-mentioned modulating module 233 includes a first multiplexer 2331, a second multiplexer 2333, a third multiplexer 2335 and a fourth multiplexer 2337, wherein the outputs of the first multiplexer 2331 and second multiplexer 2333 are controlled by selection signals sel_0, sel_1, and the outputs of the third multiplexer 2335 and fourth multiplexer 2337 are controlled by selection signal sel_2. The described selection signals sel_0, sel_1 and sel_2 may be user's input values or system's setup values. The receiver can coordinate the transmission sequence of differential signal of the transmitter through the switching of selection signals sel_0, sel_1 and sel_2, so as to correctly receive the differential signal. The modulation sequences of differential signal are shown in the following Table 1:

TABLE 1

| {sel_2, | | | | | | | | |
|---|---|---|---|---|---|---|---|---|
| sel_1, | | | | | | | | |
| sel_0} | 000 | 001 | 010 | 011 | 100 | 101 | 110 | 111 |
| Pad_A | S+ | S− | S+ | S− | D+ | D+ | D− | D− |
| Pad_B | S− | S+ | S− | S+ | D− | D− | D+ | D+ |
| Pad_C | D+ | D+ | D− | D− | S+ | S− | S+ | S− |
| Pad_D | D− | D− | D+ | D+ | S− | S+ | S− | S+ |

If the differential signal of the transmitter 21 is transferred respectively via interface pins a, b, c, d in a transmission sequence of {D+, D−, S+, S−}, then the modulating module 233 will switch the selection signals {sel_2, sel_1, sel_0} to {100}, and after that the transmitting unit 231 receives the differential signal in the sequence {D+, D−, S+, S−}, the data flow D and the status of clock signal S will be adjusted through the internal circuit of the modulating module 233, so as to match the reception sequence of differential signal internally defined by the differential signal modulating apparatus 23. Other transmission sequence combinations may also be used to switch the corresponding selection signals based on Table 1, so as to match the transmission sequence of differential signal of the transmitter 21.

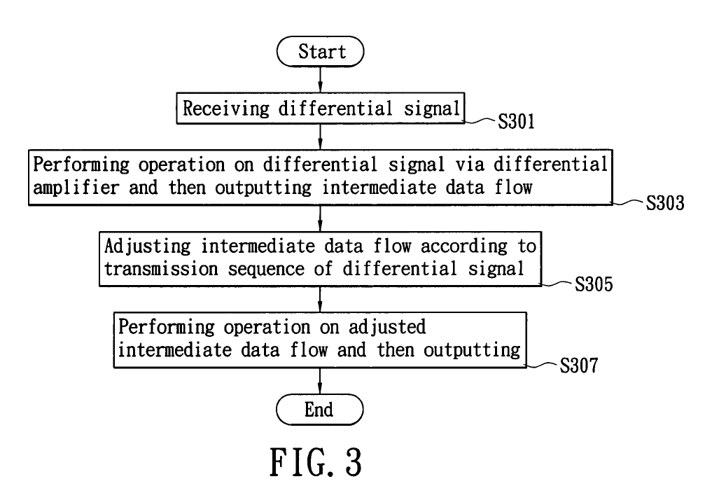

For further understanding the operations of the differential signal modulating apparatus 23 in details, refer now to FIG. 3, in which a step-wise flowchart of the modulation method of the differential signal modulating apparatus according to an embodiment of the present invention is shown, wherein the related system architecture thereof may be referred to FIG. 2 and Table 1. The differential signal of the transmitter 21 is sent in the transmission sequence {D+, D−, S+, S−}, as shown in FIG. 3, and the described modulation method of the differential signal includes the following steps:

First, the transmitting unit 231 receives differential signal (step S301), and, after the reception of the data positive signal D+ and data complementary negative data D−, the differential amplifier 2311 performs operations on them and outputs an intermediate data flow, and after the reception of the clock positive signal S+ and clock complementary negative data S−, the differential amplifier 2313 performs operations on them and outputs an intermediate clock signal (step S303);

Thereafter, the modulating module 233 sets the selection signals {sel_2, sel_1, sel_0} according to the transmission sequence {D+, D−, S+, S−} for adjusting the intermediate data flow and the status of intermediate clock signal and then outputs (step S305);

Finally, the operational module processes the operationally-adjusted intermediate data flow according to the adjusted intermediate clock signal, and then further outputs the multimedia stream MD (step S307).

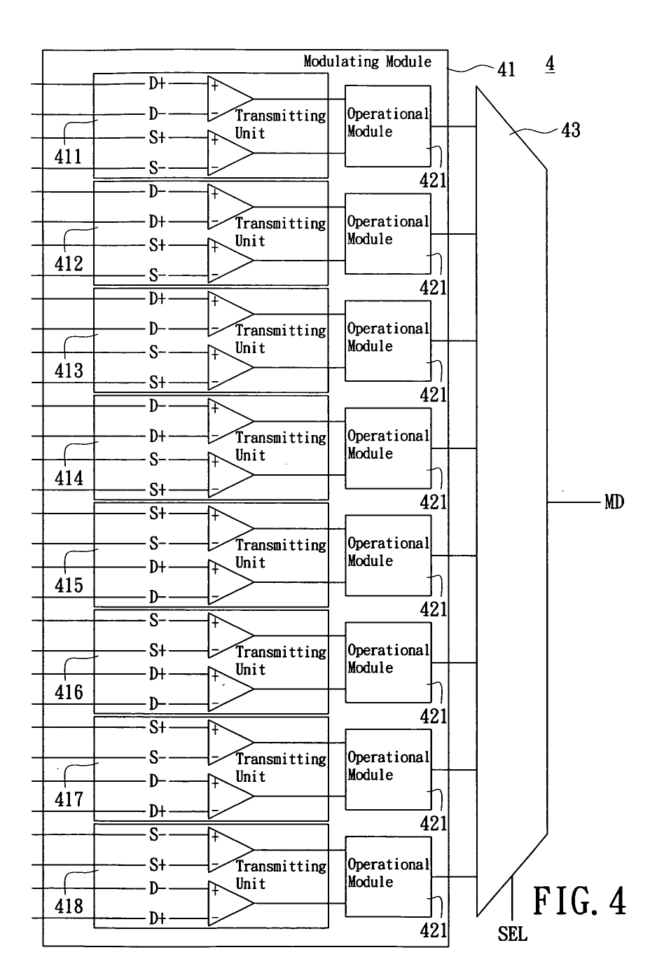

Referring now to FIG. 4, therein a system architecture diagram of a differential signal modulating apparatus according to another embodiment of the present invention is shown. FIG. 4 illustrates a system architecture partly modified from the architecture in FIG. 2, hence reference is made in conjunction with FIG. 2. As depicted in FIG. 4, the differential signal modulating apparatus 4 includes a modulating module 41 and a multiplexer 43. The described modulating module 41 includes eight (8) transmitting units 411˜418, each transmitting units 411˜418 employs differential amplifier to receive different combination sequence of differential signal, and performs operations then outputs a data flow and a clock signal; 8 operational modules 421˜428 are respectively coupled with the transmitting unit 411 in one-by-one fashion, each operational modules 421˜428 is used to receive the data flow according to the status of the clock signal, and performs operations on the said data flow, then further outputs an intermediate multimedia stream. The Multiplexer 43 is coupled with all the operational modules 421˜428, and, according to a selection signal SEL, outputs one of these intermediate multimedia stream as the multimedia stream MD. Here, the selection signal SEL may be a user's input value or a system's setup value, and, through the switching of the selection signal SEL, the receiver may coordinate the transmission sequence of the differential signal of the transmitter.

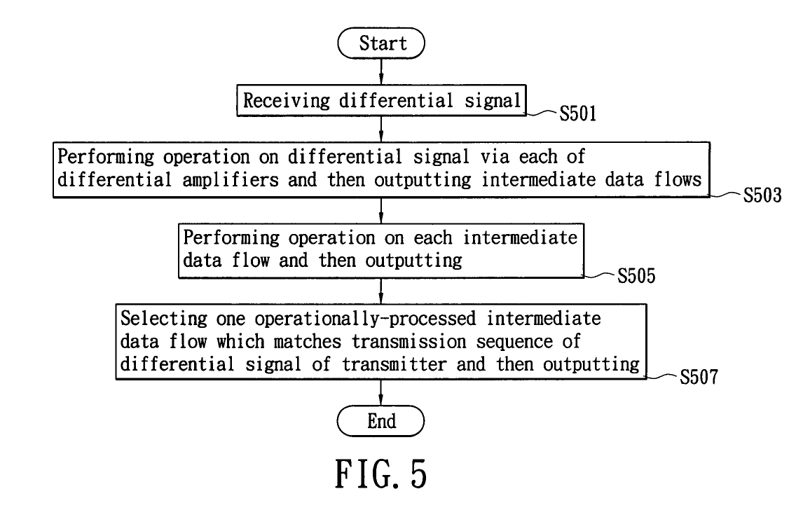

For further understanding the operations of the differential signal modulating apparatus 4, refer now to FIG. 5, in which a step-wise flowchart of the modulation method of the differential signal modulating apparatus according to another embodiment of the present invention is shown. Herein refer to FIG. 4 for the relevant system architecture. It is assumed that the transmitter still transmits in the transmission sequence {D+, D−, S+, S−}, as shown in FIG. 5, and the described modulation method of the differential signal includes the following steps:

Initially, transmitting units 411˜418 with different reception sequences are all defined to receive differential signal in the transmission sequence {D+, D−, S+, S−} (step S501), and the differential amplifiers performs operations on each combination sequence of differential signal then outputs eight (8) intermediate data flows and eight (8) intermediate clock signals (step S503);

Thereafter, the operational modules 421˜428 perform operations on the said intermediate data flow according to the received intermediate clock signal, then outputs (step S505);

Finally, since the sequence of differential signal received by the transmitting unit 411, {D+, D−, S+, S−}, is identical to the transmission sequence defined by the transmitter, the multiplexer 43 selects the differential signal received from the transmitting unit 411, and performs operations on the intermediate data flow, thus obtaining the desired multimedia stream MD (step S507).

In an embodiment, the above-mentioned transmitting unit is a Low Voltage Differential Signal (LVDS) transmitter. And the described process operations on data include compression, decompression, combination, collection etc.

The described differential signal modulating apparatus of the present invention is suitable for circuits which require conversion of differential signal to general data flow, e.g. mobile phone cam module, camera module and so on.

By the description of the above examples, it should appreciate that the differential signal modulating apparatus of the present invention and method thereof is that, before the reception of digital imaging data, the transmission sequence of differential signal at the receiver is first modulated to match the transmission sequence of differential signal transferred from the transmitter; or set up all combination sequences of differential signal at the receiver, so as to coordinate to receive different transmission sequences of differential signal. It is thus not limited by the interface of the transmitter, and the interfaces freely developed can be conveniently integrated into system chips, so as to be further flexibly applied to various products.

The above-mentioned illustrations present simply the detailed descriptions and drawings of the embodiments of the present invention, without any intention to restrict the scope of the present invention thereto. The entire range of the present invention should be based on the subsequent claims, and all changes, substitutions or modifications that persons skilled in the art can easily consider and fabricate fall within the scope of the present invention delineated by the claims.

What is claimed is:

1. A differential signal modulating apparatus, which is used for receiving a differential data pair and a differential clock pair sent from a transmitter; wherein the transmitter defines a differential signal reception sequence to transfer the differential data pair and the differential clock pair, wherein the differential signal modulating apparatus includes:
a transmitting unit, which includes a plurality of differential amplifiers, used for receiving differential data pair and differential clock pair; and
a modulating module, which is coupled with the transmitting unit, used for adjusting the reception sequence of the differential data pair and the differential clock pair according to differential signal reception sequence, so as to further output a data flow and a clock signal.

2. The differential signal modulating apparatus according to claim 1, wherein the transmitting unit is a Low Voltage Differential Signaling (LVDS) transmitter.

3. The differential signal modulating apparatus according to claim 1, wherein the differential signal modulating apparatus further includes an operation module, which is coupled with the modulating module, used for receiving the data flow according to the status of the clock signal, and for further data flow process operation.

4. The differential signal modulating apparatus according to claim 1, wherein the modulating module includes a plurality of multiplexers, in which the output of each multiplexer is controlled by a selection signal.

5. The differential signal modulating apparatus according to claim 4, wherein the selection signal is a user's input value or a system's setup value.

6. A differential signal modulating apparatus, which is used for receiving a differential data pair and a differential clock pair sent from a transmitter; wherein the transmitter defines a differential signal reception sequence for transferring the differential data pair and the differential clock pair, wherein the differential signal modulating apparatus includes:
a modulating module, which includes:
a plurality of transmitting units, which define all reception sequences of the differential data pair and the differential clock pair, and each transmitting unit receives the differential data pair and the differential clock pair, and generates a data flow and a clock signal through a plurality of differential amplifiers; and
a plurality of operation modules, which are coupled with the transmitting units in a one-to-one fashion, and each operation module is used for receiving the data flow according to the status of the clock signal, and for further data flow process operation, so as to generate the intermediate multimedia stream; and
a multiplexer, which is coupled with the operation module, and controlled by a selection signal to output one of the intermediate multimedia streams as the multimedia stream.

7. The differential signal modulating apparatus according to claim 6, wherein the transmitting units are Low Voltage Differential Signaling (LVDS) transmitters.

8. The differential signal modulating apparatus according to claim 6, wherein the selection signal is a user's input value or a system's setup value.

9. A method of differential signal modulation, which is applicable for receiving one or more differential pairs from a transmitter, in which the transmitter defines a differential signal reception sequence for transferring the differential pair, the method of differential signal modulation includes the following steps:
utilizing one or more differential amplifier to operate the differential pair and then outputting; and
selecting the suitable reception sequence of the differential pair to transfer the differential pair.

10. The method of differential signal modulation according to claim 9, wherein, in the step of selecting the suitable differential pair reception sequence, the differential pair reception sequence is adjusted according to the differential signal reception sequence.

11. The method of differential signal modulation according to claim 9, wherein, in the step of performing operations on the differential pair through differential amplifier, the receiver receives the differential pair according to the differential pair reception sequence, and outputs a plurality of intermediate data flows through the operation of the differential amplifier.

12. The method of differential signal modulation according to claim 10, wherein, after the step of selecting the suitable differential pair reception sequence, include the following step:
performing process operation on the operationally-adjusted differential pair for further outputting a multimedia stream.

13. The method of differential signal modulation according to claim 11, wherein, before the step of selecting the suitable differential pair reception sequence, include the following step:
processing each of the intermediate data flows.

14. The method of differential signal modulation according to claim 13, wherein, in the step of selecting the suitable differential pair reception sequence, one of the intermediate data flows is selected as an output according to the differential signal reception sequence.
